(19) United States
(12) Patent Application Publication
(10) Pub. No.: US 2014/0095578 A1
(43) Pub. Date: Apr. 3, 2014

(54) SYSTEMS AND METHODS FOR CAPABILITY SHARING OVER A COMMUNICATIVE LINK

(71) Applicants: VENKATESH RAJENDRAN, Beaverton, OR (US); ABDUL R. ISMAIL, Beaverton, OR (US); CHARLES L. BRABENAC, Portland, OR (US); KRISTOFFER D. FLEMING, Chandler, AZ (US); BAHAREH SADEGHI, Portland, OR (US)

(72) Inventors: VENKATESH RAJENDRAN, Beaverton, OR (US); ABDUL R. ISMAIL, Beaverton, OR (US); CHARLES L. BRABENAC, Portland, OR (US); KRISTOFFER D. FLEMING, Chandler, AZ (US); BAHAREH SADEGHI, Portland, OR (US)

(21) Appl. No.: 13/629,785

(22) Filed: Sep. 28, 2012

(51) Int. Cl. G06F 9/54

(52) U.S. Cl. CPC G06F 9/54; H04L 67/42
USPC 709/203; 719/313

(57) ABSTRACT

Systems and methods that provide that provide the sharing of capabilities over a communicative link, such as a network, is disclosed. The capabilities may be shared seamlessly between electronic devices by using preexisting device drivers.

### FIELD OF THE DISCLOSURE

The present disclosure relates to systems and methods for sharing capabilities across electronic devices, and more particularly, sharing capabilities across electronic devices over a communicative link,

### BACKGROUND OF THE DISCLOSURE

Electronic devices may have a variety of capabilities associated therewith. These capabilities may be in the form of sensors, hardware accelerators, software modules, and/or user interfaces, such as input/output (I/O) interfaces. For example, some electronic devices, such as smart phones, may have image sensors or microphones on the electronic device configured to provide a signal indicative of sensed environmental factors. These signals may be received by one or more processors on the electronic device using one or more drivers for controlling and receiving input from the associated sensors providing the signal. The signals may further be processed to provide functionality and/or capability that may be used and/or interacted with by a user of the electronic device.

The capabilities related to I/O interfaces, hardware accelerators, software modules, and/or sensors on an electronic device may be controlled by any variety of suitable drivers and/or standards. These drivers and/or standards may define connectors, cables, and/or specifications for the capability to communicate with the electronic device.

### BRIEF DESCRIPTION OF THE FIGURES

Reference will now be made to the accompanying drawings, which are not necessarily drawn to scale, and wherein:

FIG. 1 is a simplified schematic diagram illustrating an example capability sharing environment via a communicative connection between two electronic devices that can be operated in accordance with illustrative embodiments of the disclosure.

FIG. 2 is a simplified block diagram illustrating elements of the example electronic devices of FIG. 1 that can share capability via a communicative connection in accordance with illustrative embodiments of the disclosure.

FIG. 3 is a simplified block diagram illustrating functional blocks of the example electronic devices of FIG. 1 that can share capability via a communicative connection in accordance with illustrative embodiments of the disclosure.

FIG. 4 is a flow diagram illustrating an example method for establishing a capability sharing connection by a client device in accordance with illustrative embodiments of the disclosure.

FIG. 5 is a flow diagram illustrating an example method for establishing a capability sharing connection by a server device in accordance with illustrative embodiments of the disclosure.

FIG. 6 is a flow diagram illustrating an example method for receiving a capability signal by the client device in accordance with illustrative embodiments of the disclosure.

FIG. 7 is a flow diagram illustrating an example method for transmitting a transfer signal by the server device in accordance with illustrative embodiments of the disclosure.

### DETAILED DESCRIPTION OF EMBODIMENTS OF THE DISCLOSURE

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Embodiments of the disclosure may provide systems and methods for sharing capabilities between one or more electronic devices over a communicative channel, such as a network connection. In the context of this disclosure, capabilities may entail one or more functions of a particular device such as signals that may be acquired by a device in response to input to the device. These capabilities may include, but are not limited to, sensor signals, hardware accelerators, software modules, electronic storage device signals, or input interface signals of a particular device. The capabilities may be provided to the electronic device via one or more components of the device that generate one or more signals associated with the capability. For example, components of an electronic device may include one or more image sensor(s), microphone(s), accelerometer(s), gyroscope(s), touch sensitive screen(s), electronic storage device(s), or the like. These components may provide the electronic device with a component signal that may be particular to the component. One or more driver(s), such as drivers implemented in software, hardware, or a combination thereof, may be used by the electronic device and one or more processors thereon to interpret the component signals and to use the component signals for providing one or more respective capabilities to functions on the electronic device. For example, component signals may be interpreted using a driver and may be provided to one or more applications and/or programs executed by the one or more processors of the electronic device.

In certain embodiments, one or more capabilities of a particular electronic device may be shared with another electronic device over a communicative channel, such as a network connection, by utilizing pre-existing drivers associated with the shared capabilities. A server electronic device, or otherwise an electronic device that is sharing one or more capabilities associated with one or more respective components thereon, may use one or more pre-existing drivers to encode the capability signals and generate one or more transfer signals. The transfer signals may be transmitted to a client electronic device, or otherwise an electronic device that is receiving shared capability from the server device, via a pre-established communicative channel and/or network between the client, device and the server device. In one aspect, the client device may be capable of receiving the transfer signal and identifying appropriate driver(s) to generate capability signals based on the respective received transfer signals. The client device may further provide the received capability signals to one or more applications executed on the client device and processors thereon for the purposes of providing functionality to users of the client device. It will be appreciated, therefore, that the client electronic device may utilize one or more pre-existing drivers to enumerate the sharing of one or more remote capabilities.

As a non-limiting example of capability sharing, consider that the server device is a smart phone with an image sensor or camera thereon that generates an image sensor signal. The image sensor signal may be received by processors on the server device and subsequently transformed to emulate a virtual USB image sensor and shared and/or advertised over the network as a USB capability. The server device may further packetize the image sensor USB signal, such as by segmenting and attaching headers and footers, to generate a transfer signal. The transfer signal may then be transmitted via a communicative channel, such as a wireless fidelity (Wi-Fi) or Bluetooth (BT) connection, to the client device. The client device may be a desktop computer. The client device may receive the transfer signal and may decapsulate the frames of the transfer signal and present the remote capability in a manner similar to a local USB device. The client device, and any application running thereon, may then seamlessly use the remote image sensor capability. The image sensor signal may be used by any application on the client device suited for using USB image sensor devices for any variety of purposes, such as displaying the image sensor signal on the client device. It will be appreciated that the desktop computer may now receive the image sensor signal from the smart phone remotely over a communicative channel using pre-established drivers and/or communications standards. The desktop computer may then provide the shared capability to an application on the desktop computer, such as a movie recording studio software application running on the processor(s) of the desktop computer.

The systems and methods disclosed herein may further include mechanisms to discover and establish a capability connection between the client device and the server device. This mechanism, in certain embodiments, may entail the server device generating one or more messages indicative of capabilities that the server device may be able to provide to the client device. The client device may receive the one or more messages that indicate the capabilities of the server device via one or more communicative channels, such as a network connection. The client device may next solicit input from a user to ascertain which of the capabilities available from the server device are requested by the user and may generate a capability request message based thereon. The client device may, upon receiving an indication of the user requested capabilities, determine whether the drivers associated with the requested capabilities are available to the client device. If the drivers are not available, then the client device may locate where the drivers may be available and subsequently retrieve the required drivers, such as from the Internet. Indeed, the same or a different communicative channel used for communicating the capability message may be used by the client device to retrieve drivers to enable the capability connection. The client device may generate a capability request message based at least in part on the capabilities offered by the server device and the selection of capabilities by the user of the client device. The client device may transmit the capability request message, and the capability request message may be received by the server device. Upon receiving the capability request message, the server device may establish a capability connection and transmit a confirmation of the capability connection to the client device to confirm the established capability connection.

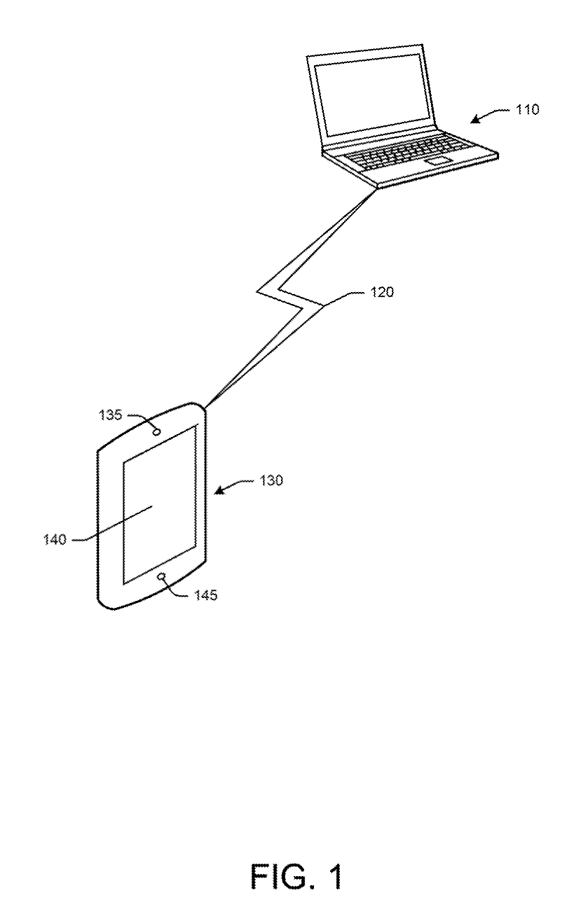

Referring now to FIG. 1, a simplified schematic diagram illustrating an example capability sharing environment via a communicative connection 120 between two electronic devices 110, 130 that can be operated in accordance with illustrative embodiments of the disclosure is discussed. The electronic device 110 may be the client device and, therefore, may receive a transfer signal associated with a capability signal from the server device 130. The server device 130 may include one or more sensor components 135 and/or user input and/or input/output (I/O) components 140, 145. The components 135, 140, 145 may include, but are not limited to, image sensors, microphones, touch sensitive inputs, touch screen displays, pointing components, mice, buttons, switches, electronic storage or memory components, haptic input components, accelerometers, gyroscopes, or combinations thereof. The components may provide a variety of suitable capabilities including, but not limited to, image capabilities, video capabilities, audio capabilities, user interface capabilities, storage capabilities, I/O capabilities, diagnostic capabilities, communications capabilities, or the like. The communicative connection 120 may be any suitable communicative connection such as network connections and/or point-to-point connections. Some examples of communicative connections may include a Wi-Fi connection, a Bluetooth connection, a direct Wi-Fi connection, a hardwired connection, a network connection, a cellular network connection, a connection, a 4G long term evolution (LTE) connection, or combinations thereof. In certain cases, there may be multiple communicative connections 120 between the client device 110 and the server device 130 from which one or more communicative connections may be used on the basis of communications bandwidth, communications latency, communications cost, energy depletion or power usage, or any other suitable considerations.

In certain embodiments, the server device 130 may be configured to share the capabilities provided by the components 135, 140, 145 with the client device 110 via the communicative connection 120. The server device 130 may be configured to receive capability signals from the components 135, 140, 145 and may use one or more drivers stored thereon or elsewhere to generate a transfer signal that may be transmitted to the client device 110 via the communicative connection 120. The client device 110 may be configured to receive the transfer signal and may use one or more drivers to extract the component signal from the transfer signal. The client device 110 may further provide the component signal to one or more applications running on the client device 110.

While the client device 110 and the server device 130 are depicted as a laptop computer and a smart phone, respectively, it will be appreciated that the client device 110 and the server device 130 may be any suitable electronic device. Indeed, the electronic devices 110, 130 may include, but are not limited to, a mobile phone, a smart phone, a watch, a tablet computer, a laptop computer, a personal digital assistant (PDA), a personal computer (PC), a desktop computer, a server, a tablet computer, or any other computing device. In some cases, the client device 110 may be the same type of device as the server device 130.

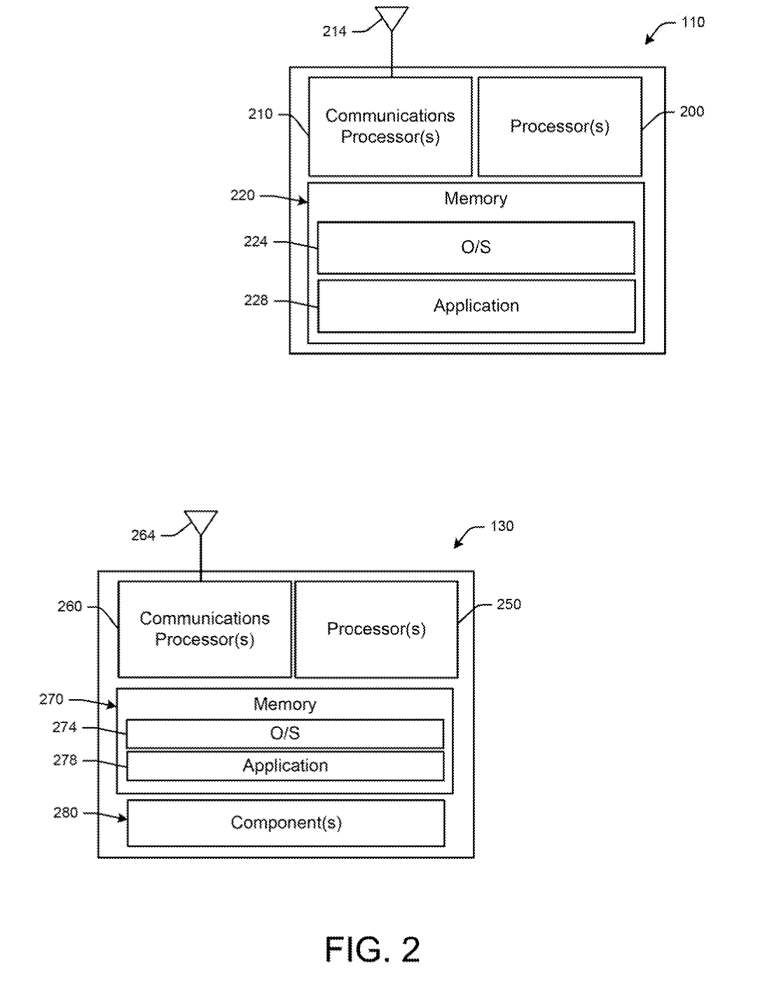

Referring now to FIG. 2, a simplified block diagram illustrating elements of the example electronic devices 110, 130 of FIG. 1 that can share capability via the communicative connection 120 in accordance with illustrative embodiments of the disclosure is discussed. The client device 110 may include one or more processors 200, one or more communications processors 210, one or more antennas 214, and/or one or more memories 220. As depicted herein, the processors 200 may be configured to operate instructions, applications, and/or software associated with services provided by the client device 110. These instructions, applications, and/or software may be stored on the memory 220, depicted as one or more operating systems (O/S) 224 and/or one or more applications 228, and may be retrievable, and executable by the processors 200. Alternatively, the instructions, applications, and/or software executed by the processors 200 may be stored in any suitable location, such as the cloud or other remote locations. The instructions, applications, and/or software modules, such as O/S 224 and/or application 228 may or may not correspond to physical locations and/or addresses in the memory 220. In other words, the contents of each of the modules may not be segregated from each other and may, in fact, be stored in at least partially interleaved positions on the memory 220.

The processor(s) 200 may include, without limitation, a central processing unit (CPU), a digital signal processor (DSP), a reduced instruction set computer (RISC), a complex instruction set computer (CISC), or any combination thereof. The client device 110 may also include a chipset (not shown) for controlling communications between the processor(s) 200 and one or more of the other components of the client device 110. In one embodiment, the client device 110 may be based on an Intel® Architecture system, and the processor(s) 200 and the chipset may be from a family of Intel® processors and chipsets, such as the Intel® Atom® processor family. The processor(s) 200 may also include one or more processors as part of one or more application-specific integrated circuits (ASICs) or application-specific standard products (ASSPs) for handling specific data processing functions or tasks.

The communications processor(s) 210 may be configured to communicate with the processors 200 or other elements of the client device 110 to transmit and/or receive communications signals, such as from the server device 130 via any suitable communications mechanism, link, channel, or standard. The communications processor 210 may be configured to receive a communications signal and appropriately modulate, or otherwise transform, the signal and provide the signal to the antenna 214 for transmission via wireless channels, such as Wi-Fi. The communications processors 210 may further be configured to receive communications signals from the antenna 214 and demodulate, or otherwise transform, the received signals, and provide the transformed signals to the processors 200 for further processing and/or storage. In certain aspects, the communications processors 210 may enable communications using a variety of modulation schemes, standards, and channels. In some cases, the communications processors 210 may be a separate element from the processors 200 and, in other cases, the communications processors 210 may be integrated with the processors 200.

The memory 220 may include one or more volatile and/or non-volatile memory devices including, but not limited to random access memory (RAM) dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The O/S 224 may be configured to enable the operation of the one or more applications 228 on the processors 200. In one aspect, the O/S 224 may provide a common interface for the application 228 to interface with, utilize, and/or control the various hardware elements of the client device 110. The details of operating systems are well-known and will not be discussed in significant detail herein. Example operating systems may include, but are not limited to, Google® Android®, Apple® iOS®, Microsoft® Windows Mobile®, Microsoft® Windows 7®, or the like. In certain aspects, such as in the context of providing sharing capability across electronic devices 110, 130, such as via a network, the O/S 224 may provide functionality and enable the sharing of capability. In certain embodiments, the O/S 224 may provide capability sharing services to the application 228.

The one or more antenna(s) 214 may be any suitable antenna for wireless communications. The antennas 214 may be uni-directional, bi-directional, or omni-directional. In certain embodiments, the antenna may be a patch antenna. In some cases, the antenna 214 may be integrated with one of the communications processors 210, the processors 200, or any other elements of the client device 110.

The server device 130 may include one or more processors 250, one or more communications processors 260, one or more antennas 264, one or more memories 270, and one or more component(s) 280. The one or more processors 250, the one or more communications processors 260, the one or more antennas 264, and the one or more memories 270 may be similar or the same as one or more processors 200, the one or more communications processors 210, the one or more antennas 214, and the one or more memories 220, respectfully. In the interest of brevity, discussion of each of these elements will not be repeated.

The one or more components 280 may include one or more image sensor(s), microphone(s), accelerometer(s), gyroscope(s), touch sensitive screen(s), electronic storage device(s), or the like. These components may provide the electronic device with a component signal that may be suitable for sharing with the client device 110 in accordance with the example methods discussed herein.

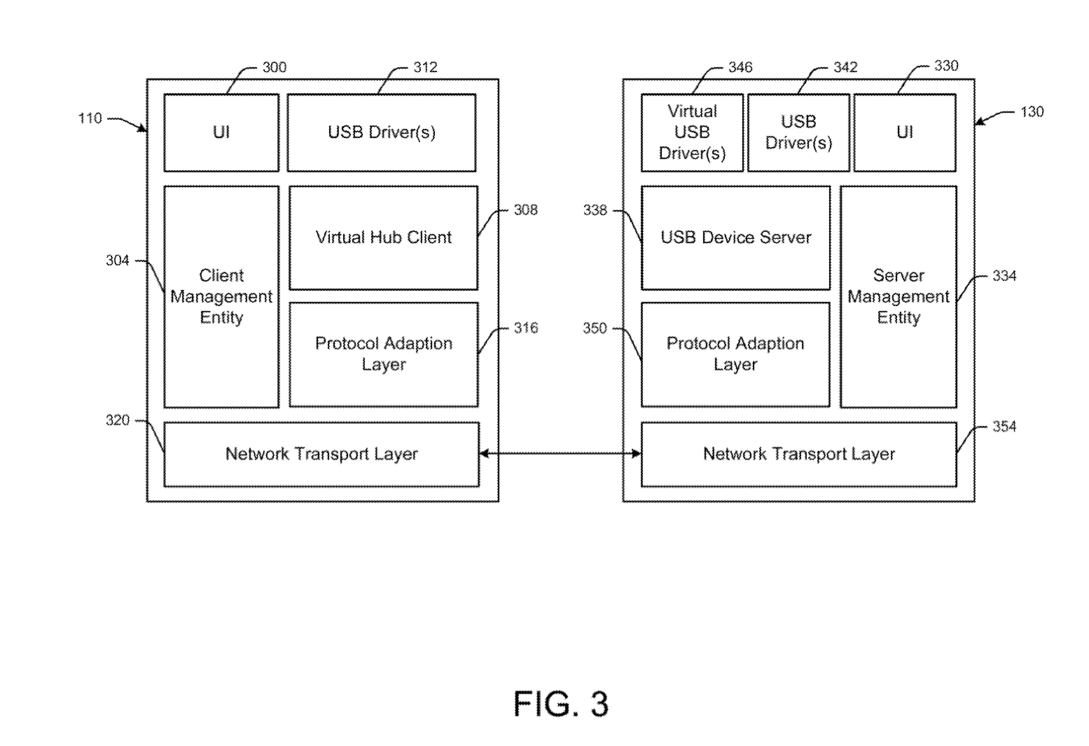

Referring now to FIG. 3, a simplified block diagram illustrating functional blocks of the example electronic devices 110, 130 of FIG. 1 that can share capability via the communicative connection 120 in accordance with illustrative embodiments of the disclosure is discussed. The functional elements described with reference to FIG. 3 for both the client device 110 and the server device 130 may be implemented in software, hardware, or a combination of software and hardware. The client device 110 may include a user interface (UI) 300, a client management entity 304, a virtual hub client 308, one or more USB driver(s) 312, a protocol adaption layer 316, and a network transport layer 320.

The UI 300 may enable the client device 110 to interact with a user of the client device 110. The UI 300 may be, for example, a touch screen display, a keyboard, or the like. The client device 110 may be configured to receive input pertaining to requested capabilities by the user of the client device 110 via the UI 300. The client management entity 304 may be configured to provide general functionality for receiving shared capability signals from the server device 130. In one aspect, the client management entity 304 may be configured to interact with the UI 300 and other entities to receive indications of capabilities available for sharing by the server device 130 and ma receive indications of user selection of a subset of those capabilities that are available for sharing. The client management entity 304 may further be configured to direct the extraction of USB signals or capability signals from transfer signals received by the client device 110 from the server device 130. Further still, the client management entity 304 may be configured to provide the capability signals associated with the shared capabilities to the O/S 224 and/or one or more applications 228 of the client device 110. In certain further embodiments, the client management entity 304, while setting up a capability connection between the client, device 110 and the server device 130, may determine that the client device 110 may not have the appropriate USB drivers to utilize the shared capability. In this case, the client management entity 304 may be configured to determine where the suitable USB drivers associated with the requested capabilities may be found and may retrieve the drivers from those identified sources. In some cases, therefore, the client management entity 304 may access sources external to the client device 110, such as the Internet, to retrieve suitable drivers associated with the requested and/or received shared capability.

The virtual hub client 308 may be configured to receive USB signals associated with the shared capability between the client device 110 and the server device 130 and translate and/or transform them to capability signals using appropriate USB drivers 312. Therefore, the virtual hub client 308 may receive signals associated with the shared capability after transmission-related metadata and transmission overhead have been stripped from the signals. The virtual hub client 308 may be configured to ascertain the appropriate USB driver(s) 312 that may be used to manage and/or extract the received capability signals. The virtual hub client 308 may further be configured to provide the received capability signal and/or associated USB signal to the client management entity 304 for further disbursement to the O/S 224 and/or applications 228 that may require the shared capability and associated signals.

The protocol adaption layer (PAL) 316 may be configured to receive the transfer signal associated with a shared capability from the network transport layer 320 and condition the received signal prior to providing the signal to the virtual hub client 308 for further processing. The PAL 316 may be configured to strip headers and/or footers associated with transmitting the transfer signals between the server device 130 and the client device 110 via the network transport layer 320. The PAL 316 may further be configured to reconstruct the transfer signal from individual data packets of the transfer signal as received from the network transport layer 320.

The network transport layer 320 may incorporate the infrastructure, both physical and instructions for communicating between the client device 110 and the server device 130. In one aspect, the network transport layer 320 may packetize the transfer signals that may be transferred between the two electronic devices 110, 130. In another aspect, the network transport layer 320 may provide transport layer level security services in communicating between the client device 110 and the server device 130.

Still referring to FIG. 3, the server device 130 may include functional blocks of a user interface (UI) 330, a server management entity 334, a USB driver server 338, USB driver(s) 342, USB virtual drivers 346, a protocol adaption layer (PAL) 350, and a network transport layer 354. The UI 330 of the server device 130 may be similar to the UI 300 of the client device 110 in that a user may interact with the server device 130 via the UI 330. In one aspect, the server device 130 may be configured to receive user permission to set up the sharing of capabilities or allow and/or disallow the sharing of capabilities between the server device 130 and the client device 110. Additionally, the UI 330 may be configured to notify the user of the server device 130 that capabilities are being shared with a client device 110.

The server management entity 334 may be configured to provide general functionality for transmitting shared capability signals to the client device 110. In one aspect, the server management entity 334 may be configured to direct an indication of capabilities that are available for sharing by the server device 130. In other words, the server management entity 334 may be configured to advertise to potential client devices 110 what capabilities may be available to them. The server management entity 334 may further be configured to direct the formation of data packets of USB signals or capability signals into transfer signals transmitted by the server device 130 to the client device 110. Further still, the server management entity 334 may be configured to receive the capability signals associated with the shared capabilities from various entities on the server device 130, such as the O/S 274 and/or one or more applications 278 of the server device 130. In certain further embodiments, the server management entity 334, while setting up a capability connection between the client device 110 and the server device 130, may determine that the server device 130 may not have the appropriate USB drivers 342 and/or virtual USB drivers 346 to share the shared capability. In this case, the server management entity 334 may be configured to determine where the suitable USB drivers 342 and/or virtual USB drivers 346 associated with the requested capabilities may be found and may retrieve the drivers from those identified sources. In some cases, therefore, the server management entity 334 may access sources external to the server device 130, such as the Internet, to retrieve suitable USB drivers 342 and/or virtual USB drivers 346 associated with the requested and/or advertised shared capability.

The USB device server 338 may be configured to receive capability signals of components 280 associated with shared capability between the client device 110 and the server device 130 and from one or more components 280. The USB device server 338 may further be configured to translate and/or transform capability signals to USB signals using appropriate USB drivers 342 and/or virtual USB drivers 346. Therefore, the USB device server 338 may receive signals associated with the shared capability prior to transmission of the signals to the client device 110. The USB device server 338 may be configured to ascertain the appropriate USB driver(s) 342 and/or virtual USB drivers 346 that may be used to manage and/or encode the received capability signals to a virtual USB format. The USB device server 338 may further be configured to provide the received capability signal and/or associated USB signal to the PAL 350 for further processing for transmission via the network transport layer 354. In the context of this disclosure, virtual USB encoding may refer to encoding the capability signals from various components using USB standards and/or specifications without the use of a physical USB port, bus, and/or dongle. In other words, the USB signal may be utilized for the purposes of having a common set of standards and/or communications protocols for communicating the capability signals from a variety of components and related capabilities without having to receive or transmit the signals via any particular physical port, such as a USB port. Any suitable USB standard and/or bandwidth may be utilized, including, for example, USB 3.0. Furthermore, any suitable device class and/or combinations of device classes may be used, such as image, printer, audio, smart card, or the like. Further still, the capability sharing as described herein may utilize any one of, or a combination of isochronous transfers, interrupt transfers, and/or bulk transfers.

The PAL 350 of the server device 130 may be configured to receive the USB signal associated with a shared capability from the USB device server 338 and process the signal for transmission via the network transport layer 354. The processing of the USB signal associated with the shared capability may entail partitioning the transfer signal appropriately and adding appropriate headers and footers to constituent data packets for transmission via the communicative connection 120 and the network transport layer 354. The PAL 350 may further be configured to provide the network transport layer 354 with a transfer signal that may be suitably transmitted by the network transport layer using the communications processors 260, the antenna 264, and via the communicative connection 120.

It will be appreciated that while the USB drivers and/or standards have been discussed in the context of capability sharing between two or more electronic devices, any set of pre-existing drivers and/or standards may be used. The USB drivers and/or standards may be an attractive set of standards due to their widespread use and rich driver stack. However, a number of other drivers may be used between two or more electronic devices to share capability therebetween. For example, any one of virtual USB drivers, secure digital input output (SDIO) drivers, peripheral component interconnect express (PCIe) drivers, inter-integrated circuit (I2C) drivers, service provider interface (SPI) drivers, general purpose Input/Output (GPIO) drivers, or combinations thereof may be used.

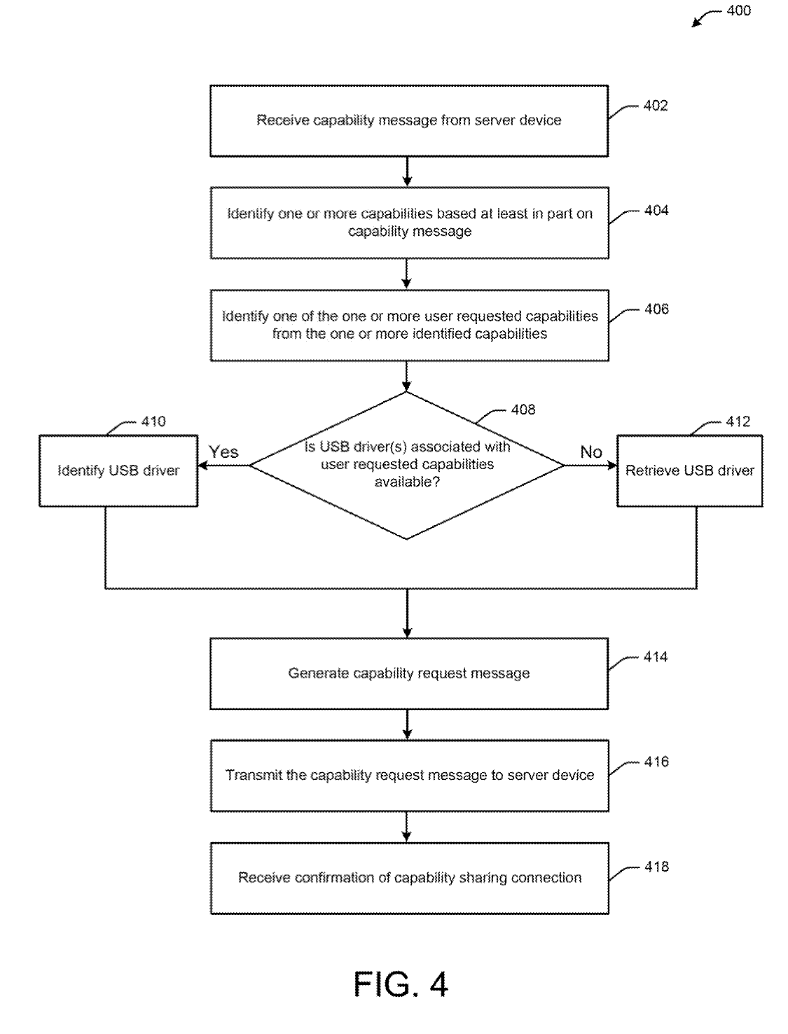

Referring now to FIG. 4, a flow diagram illustrating an example method 400 for establishing a capability sharing connection by a client device 110 in accordance with illustrative embodiments of the disclosure is discussed. The method may be performed by the client device 110, where some of the processes may receive communications from, or provide communications with, the server device 1130 or other suitable entities. At block 402, a capability message may be received from the server device. The capability message may indicate one or more capabilities that are available for sharing by the server device 130. The capability message may be in the form of one or more data packets that are generated and transmitted by the PAL 350 and the network transport layer 354 of the server device 130 to the network transport layer 320 and the PAL 316 of the client device 110. The one or more data packets that constitute the capability message may be transmitted via the communicative connection 120 or via any other suitable communicative link. The data packets may, in certain embodiments, have header and footer information thereon for the purposes of addressing or directing the data packets; identifying the length and/or content of the data packets; identifying the number of data packets; identifying the server device 130; and conducting parity checks, cyclic redundancy checks, and/or any variety of transmission quality mechanisms.

At block 404, one or more capabilities may be identified based at least in part on the received capability message. The virtual hub client 308 and/or the client management entity 304 may parse the received data packets of the capability message, and ascertain from the capability message, which capabilities are being offered for sharing by the server device 130. In one aspect, the capability message may be processed by the virtual hub client 308 or the client management entity 304 or the combination of the two to identify the capabilities available from the server device 130.

At block 406, one or more user requested capabilities may be identified from the one or more identified capabilities. The one or more available capabilities as identified at block 404 may be presented to a user of the client device 110, such as on the UI 300. From the UI 300, the user may select one or more of the available capabilities of the server device 130 to identify the one or more user requested capabilities. The client device 110 may generate a listing or an identification of the one or more user selected capabilities. In certain cases, user preferences for shared capabilities may be pre-selected, such as in the form of a user preference setting. These preferences may, in certain embodiments, be established by the user at a time prior to execution of method 400. In this case, the client device 110 may consult the user preference settings and, based at least in part thereon, identify the one or more user requested capabilities.

At block 408, it may be determined if USB driver(s) associated with the one or more user requested capabilities are available. In other words, the client management entity 304 or the virtual hub client 308 may determine if the USB driver(s) 312 include the USB driver(s) that may be used for the one or more user requested capabilities. In one aspect, the USB driver(s) 312 may have identifiers, such as unique identifiers, associated therewith to enable identification of USB driver(s) that may be required for a particular capability that might be shared by the server device 130. If at block 408 it is determined that the required USB driver(s) are available, then the USB drivers may be identified at block 410 for use during the sharing of the capabilities from the server device 130. On the other hand, if at block 408 it is determined that the USB driver(s) required for the one or more user requested capabilities are not stored on the client device 110, then the client device 110 and the processor(s) 200 thereon may retrieve the required USB driver(s) at block 412. Retrieving the required USB driver(s) may entail locating the USB driver(s) needed by using an identifier, such as a unique identifier of the USB driver(s). Once the USB driver(s) are identified, the client device 110 and the processor(s) 200 thereon may retrieve the identified USB driver(s) from one or more sources external to the client device 110. For example, the client device 110 may access the Internet to retrieve the required USB driver(s). In some cases, the client device 110 may access multiple sources, such as multiple websites, to retrieve the USB driver(s) needed for enabling the capability sharing between the client device 110 and the server device 130. The client device 110 may access the Internet or any other communicative channel via the communicative connection 120 or any other suitable communicative link. In other words, the client device 110 may retrieve USB driver(s) over the same or different communicative connections that may be used for the capability sharing connection between the client device 110 and the server device 130. In certain further embodiments, the client device 110 may request and/or receive the required USB driver(s) directly from the server device 130, such as via the communicative connection 120 or any other suitable communicative link. The client device 110 may further store any retrieved USB driver(s) on the memory 220, such as with the other USB drivers 312.

At block 414, the client device 110 may generate a capability request message. The capability request message may be in the form of one or more data packets with associated overhead, such as headers and footers, for reliable transmission of the payload. The capability request message may indicate which of the available capabilities from the server device 130 are requested by the client device 110. In this case, the requested capabilities may be the same as the available capabilities that can be provided by the client device 110 for use by the user of the client device 110. At block 416, the capability request message may be transmitted to the server device 130. By transmitting the capability request message, the client device 110 may inform the server device 130 of which of its capabilities are requested b the client device 110 and the user of the client device 110. The capability request may be transmitted using the communicative connection 120 or any other suitable communicative channel. Indeed, as in the case of retrieving the USB driver(s) at block 412, the same or different communications infrastructure and/or channels may be used to transmit the capability request message used for the capability sharing connection.

At block 418, the client device 110 may receive a confirmation of the capability sharing connection. At this point, the confirmation may be responsive to the server device 130 receiving and processing the capability request message that was transmitted by the client device 110 at block 416. The confirmation of the capability sharing connection may be indicative of the server device 130 agreeing to share the requested capabilities as identified in the capability request message and establishing a capability sharing connection based thereon.

It should be noted that the method 400 may be modified in various ways in accordance with certain embodiments of the disclosure. For example, one or more operations of the method 400 may be eliminated or executed out of order in other embodiments of the disclosure. Additionally, other operations may be added to the method 400 in accordance with other embodiments of the disclosure.

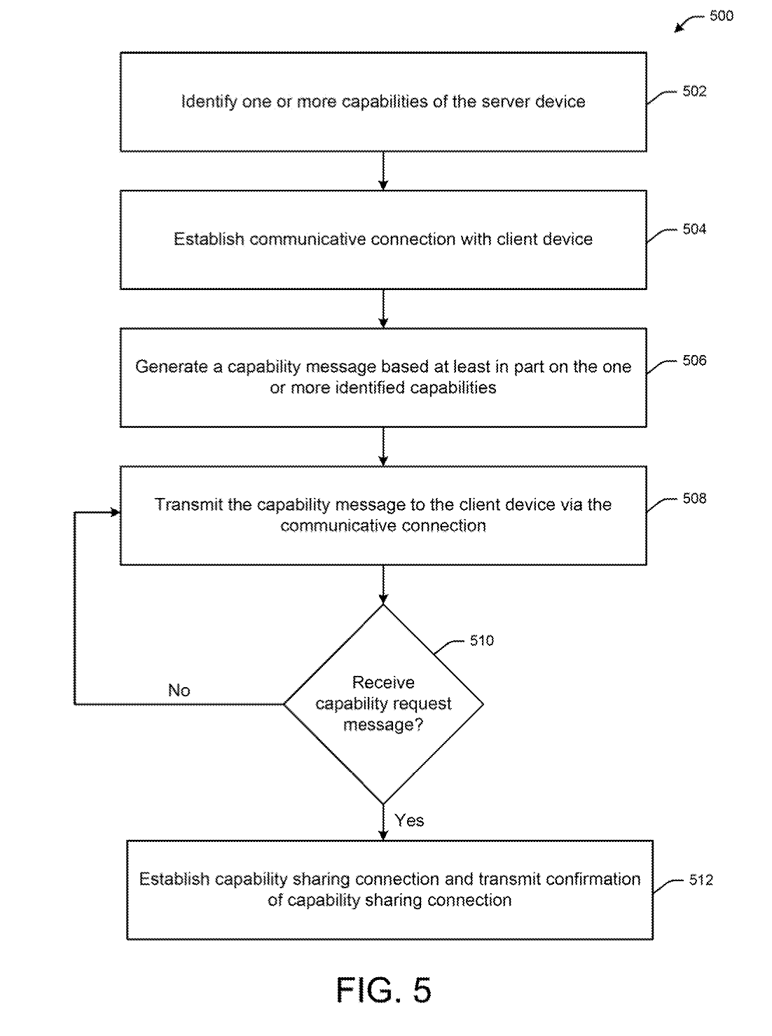

Referring nowto FIG. 5, a flow diagram illustrating an example method 500 for establishing a capability sharing connection by a server device in accordance with illustrative embodiments of the disclosure is discussed. In the implementation of method 500, the server device 130 may interact and/or communicate with the client device 110 and/or other entities. At block 502, one or more capabilities of the server device 130 may be identified. In one aspect, the server device 130 may already be aware of the capabilities and/or components associated with itself These capabilities may be aggregated and/or compiled. In certain cases, the server device 130 and the processors 250 thereon may access a configuration file, such as a configuration file stored in memory 270, to determine which components and/or associated capabilities are available on the server device 130. The server device 130 may further identify, in certain embodiments, which of the identified capabilities may be available for sharing with other electronic devices, such as the client device 110.

At block 504, the server device 130 may establish a communicative connection with the client device 110. The communicative connection may be communicative connection 120 or any other suitable communications link. In other words, the communicative connection established for the purposes of establishing a capability sharing connection may be the same or a different communicative connection 120 may be utilized for enabling the capability sharing connection. The communicative connection may be established by the server device 130 by transmitting a beacon advertising its availability and presence to the client device 110. The transmission of the beacon may be responsive to user interaction with the server device 130, such as via UI 330.

At block 506, a capability message may be generated based at least in part on the one or more identified capabilities. This capability message, as described with reference to block 402 of method 400 as depicted in FIG. 4, may include one or more data packets that encode each of the available and sharable capabilities of the server device 130. At block 508, the capability message may be transmitted to the client device 110 via the communicative connection 120. At this point, the client device 110 has information to ascertain which capabilities may be offered by the server device 130 for sharing with the client device 110.

At block 510, it may be determined if a capability request message is received. The capability message, as described with reference to block 414 of method 400 as depicted in FIG. 4, may include one or more data packets that may be indicative of the capabilities that may be requested by a user of the client device 110 for sharing by the server device 130. The capability message, therefore, may indicate which of the offered capabilities, as identified in the capability message described in blocks 506 and 508, are requested for sharing by the client device 110. If at block 510 it is determined that the capability request message is not received, then the method 500 may continue to transmit the capability message to the client device 110 at block 508. Alternatively, the method 500 may end without establishing a capability sharing connection. If however, at block 510 it is determined that the capability request message is received, then at block 512, a capability sharing connection may be established, and confirmation of the capability sharing connection may be transmitted. In one aspect, the capability sharing connection may be established over the communicative connection 120 between the client device 110 and the server device 130. The establishment of the capability sharing connection may also entail the transmission of one or more test packets in addition to the confirmation to determine if a reliable capability sharing connection has been established.

It should be noted that the method 500 may be modified in various ways in accordance with certain embodiments of the disclosure. For example, one or more operations of the method 500 may be eliminated or executed out of order in other embodiments of the disclosure. Additionally, other operations may be added to the method 500 in accordance with other embodiments of the disclosure.

It will be appreciated that upon the execution of the example methods 400 and 500 as depicted in FIGS. 4 and 5, respectively, the client device 110 and the server device 130 may be configured to share capability over the communicative connection 120. Accordingly, components 280 on the server device 130 that provide the shared capability may be identified. Further, USB drivers 342 and/or virtual USB drivers 346 associated with the shared capabilities may be identified on the server device 130. Further still, USB drivers 312 for interpreting the received transfer signals and capability signals on the client device 110 may be identified. Therefore, at this point, the server device 130 may be configured to control and receive capability signals from the one or more components 280, encode the capability signals using the USB or other drivers as transfer signals, and transmit the transfer signals. Likewise, the client device 110, at this point, may be configured to receive the transfer signals from the server device 130 and transform the transfer signals using identified USB or other drivers on the client device 110. The received capability signals may then be provided by the client device 110 and the processors 200 thereon to the O/S 224 or one or more applications 228 executed by the processors 200 to enable the functionality of the client device 110.

As a non-limiting example of the execution of the methods 400 and 500 of FIGS. 4 and 5, respectively, consider that a server device in the form of a smart phone may establish a capability sharing connection with a client device in the form of a desktop computer. In the process of doing so, the smart phone may indicate to the desktop computer that the capabilities available for sharing are audio, video, and motion, corresponding to the components of an image sensor, a microphone, and a multi-axis micro-electromechanical system (MEMS) accelerometer. A user of the desktop computer may decide that he or she wants to use the smart phone as a video game controller and may select motion detection as the requested capability. Accordingly, appropriate USB or other drivers may be identified on both the smart phone and the desktop computer, and a capability sharing connection may be established to share the motion detector capability of the smart phone with the desktop computer. Once the capability sharing connection is established, the desktop computer may be enabled to receive signals from the smart phone related to the motion detector and may provide these signals to a video game application for the purposes of providing game playing entertainment to the user of the desktop computer.

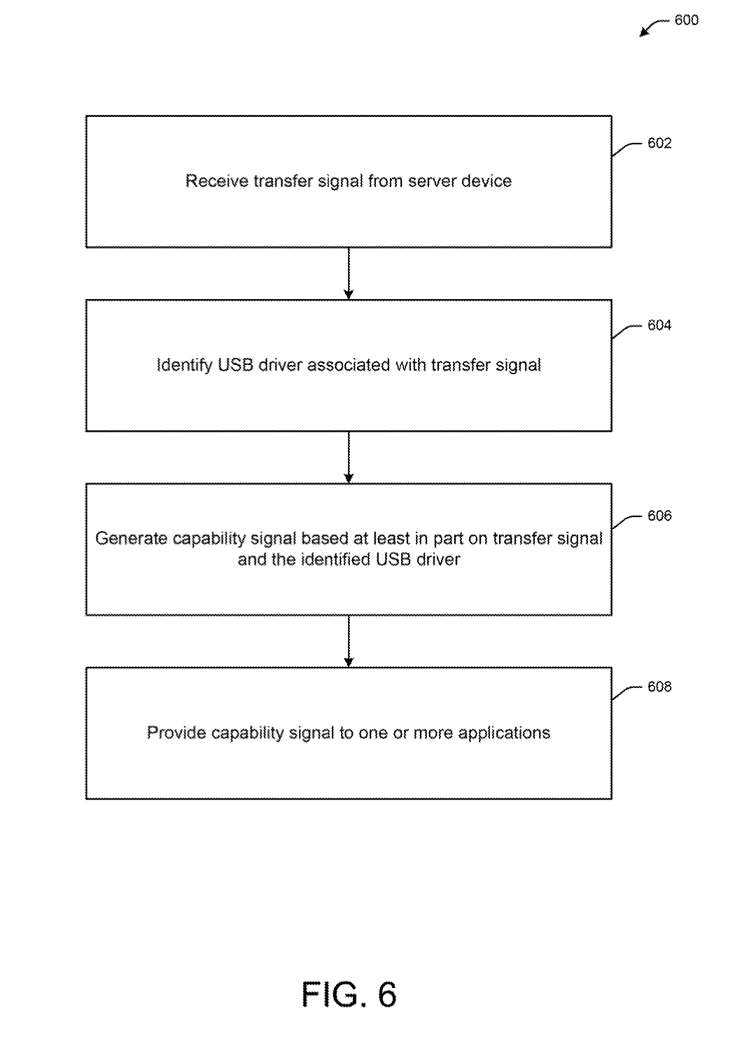

Referring now to FIG. 6, a flow diagram illustrating an example method 600 for receiving a capability signal by the client device 110 in accordance with illustrative embodiments of the disclosure is discussed. At block 602, a transfer signal may be received from the server device 130. The transfer signal may be representative of the capability signals that are provided by each of the components 280 of the server device 130. In certain embodiments, the capability signals may be transformed by the server device 130 using USB drivers 342 or virtual USB drivers 346 and then subsequently transformed further by the PAL 350 so that the information associated with the shared capabilities can be effectively communicated from the server device 130 to the client device 110. Therefore, the transfer signal received by the client device 110 may carry the information and/or data associated with the capabilities that were requested by the client device 110 at blocks 414 and 416 of method 400 as depicted in FIG. 4.

At block 604, the USB driver associated with the transfer signal may be identified. In one aspect, the USB driver may already be available to the client device 110 due to the execution of method 400 as depicted in FIG. 4, particularly with the processes of blocks 408, 410, 412. Each of the transfer signals may have different USB drivers associated therewith and, therefore, the appropriate USB driver may be selected for the particular capability signal and/or the transfer signal received.

At block 606, a capability signal may be generated based at least in part on the transfer signal and the USB driver. As described above, recovering the capability signal at the client device 110 may entail removing transmission-related overhead by the PAL 316 and reconstructing the signal using the USB driver. The capability signal may be recovered by the processors 200 using instructions and for applications stored in memory 220.

At block 608, the capability signal may be provided to one or more applications. By providing the capability signal to the one or more applications 228, the shared capability may be used by the client device 110. In effect, the client device 110 may receive component-related signals from the server device 130 and then use those signals to provide functionality to a user of the client device 110. In certain embodiments, the capability signal may be provided to the O/S 224, and the O/S 224, in turn, may provide the capability signal to the one or more applications 228.

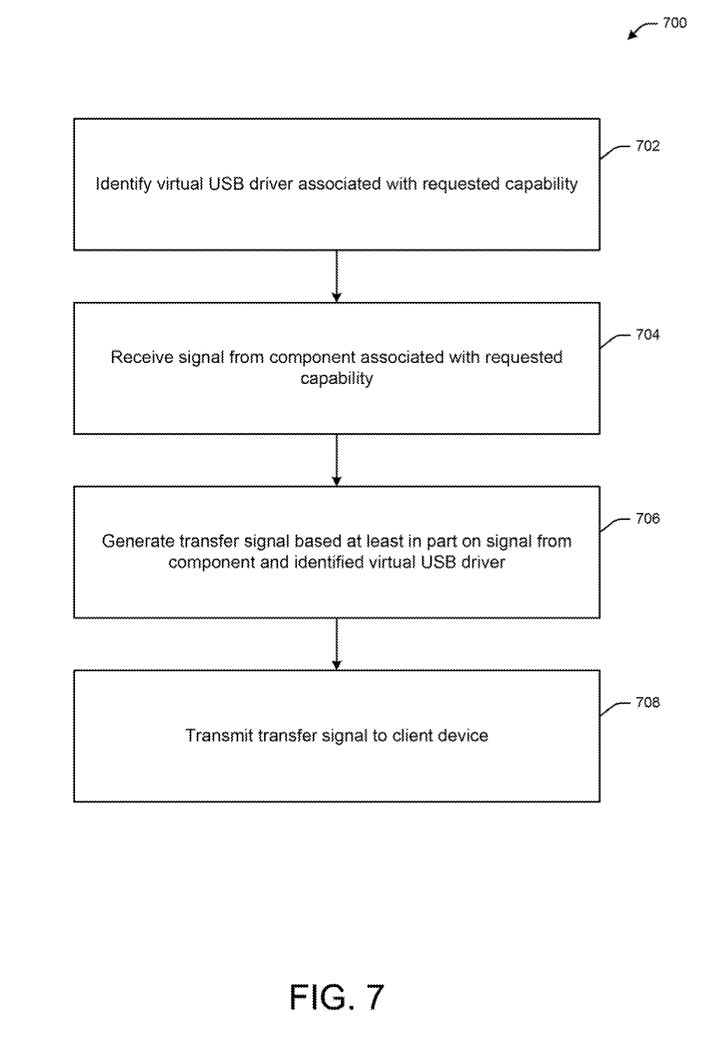

Referring now to FIG. 7, a flow diagram illustrating an example method 700 for transmitting a transfer signal by the server device 130 in accordance with illustrative embodiments of the disclosure is discussed. At block 702, a virtual USB driver associated with a requested capability may be identified. In this case, the server device 130 may receive an indication of the requested capability and, based thereon, identify the appropriate virtual USB driver 346. In certain embodiments, the server device 130 may identify an appropriate USB driver 342 instead of the virtual USB driver 346.

At block 704, a signal may be received from components associated with the requested capability. These capability signals may be identified and processed by the processors 250. At block 706, a transfer signal may be generated based at least in part on the signals from the components and an identified virtual USB driver. This process may be conducted by the processors 250 and the functional blocks of the server management entity 334, the USB device server 338, and the PAL 350. At block 708, the transfer signal may be transmitted to the client device 110. The transmission may be over the capability sharing connection as established in block 512 of method 500 as depicted in FIG. 5.

As a non-limiting example of the implementation of methods 600 and 700 of FIGS. 6 and 7, respectively, consider that a particular individual may have a tablet computing device as the server device where audio and video capability corresponding to a respective image sensor and a microphone are transmitted as a transfer signal to a netbook computer that may be the client device. In this case, the tablet computing device and the processors thereon may receive signals, such as capability signals from the image sensor and microphone, and using appropriate USB drivers convert the signals to a transfer signal for transmission to the netbook computer over a capability sharing connection established by performing methods 400 and 500 of FIGS. 4 and 5, respectively. The transfer signal may be received by the netbook computer, and using appropriate USB drivers, may be converted to the original or similar capability signals. These capability signals may then be provided to an application, such as a movie recording application, on the netbook computer. This application, under the direction of a user of the netbook computer, may use the received capability signals for rendering functionality to the user of the netbook computer.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMS) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device, or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure, including the best mode, and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method comprising:
receiving, by one or more processors, a capability message;
identifying, by the one or more processors, one or more capabilities based at least in part on the capability message;
identifying, by the one or more processors, at least one user requested capability from the one or more identified capabilities;
generating, by the one or more processors and based at least in part on the at least one user requested capability, a capability request message;
transmitting, by the one or more processors, the capability request message; and
receiving, by the one or more processors and responsive to the transmitted capability request message, a confirmation of a capability connection.

2. The method of claim 1, further comprising determining, by the one or more processors, that one or more drivers associated with the at least one user requested capability are available.

3. The method of claim 2, wherein the one or more drivers are at least one of: (i) universal serial bus (USB) device class driver; (ii) a virtual USB driver; (iii) a secure digital input output (SDIO) driver; (iv) a peripheral component interconnect express (PCIe) driver; (v) inter-integrated circuit (I2C) driver; (vi) service provider interface (SPI); or (vii) general purpose Input/Output (GPIO) driver.

4. The method of claim 2, wherein determining that one or more drivers associated with the at least one user requested capability are available comprises at least one of: (i) identifying the one or more drivers associated with the at least one user requested capability; or (ii) retrieving the one or more drivers associated with the at least one user requested capability.

5. The method of claim 1, wherein the one or more capabilities comprise at least one of: (i) an image capability; (ii) a video capability; (iii) an audio capability; (iv) a user interface capability; (v) a storage capability; (vi) an input/output capability; (vii) a diagnostic capability; (viii) a communications capability; or (ix) hardware acceleration capability.

6. The method of claim 1, further comprising receiving or transmitting one or more transfer signals corresponding to the at least one user requested capability.

7. The method of claim 6, further comprising identifying a driver associated with the transfer signal.

8. The method of claim 7, further comprising generating a capability signal based at least in part on the transfer signal and the identified driver associated with the transfer signal.

9. The method of claim 8, further comprising providing the capability signal to one or more applications.

10. An electronic device comprising:
one or more components, each component configured to provide a corresponding respective signal;
a device server configured to identify one or more capabilities corresponding to the one or more components;
a server management entity configured to generate a transfer signal based at least in part on the identified capabilities and the signals corresponding to the one or more components; and
a protocol adaption layer configured to transmit or receive the transfer signal.

11. The electronic device of claim 10, wherein the one or more components are at least one of: (i) an image sensor; (ii) a video camera; (iii) a microphone; (iv) a user interface; (v) a storage device; (vi) an input/output interface; (vii) a diagnostic component (viii) a communications interface; or (ix) hardware acceleration capability.

12. The electronic device of claim 10, wherein the one or more capabilities correspond to one or more respective virtual devices.

13. The electronic device of claim 12, wherein each of the virtual devices are configured to generate a corresponding respective virtual device signal.

14. The electronic device of claim 13, wherein the virtual device signal corresponding to each of the one or more virtual devices is based at least in part on one or more drivers.

15. The electronic device of claim 14, wherein the one or more drivers comprises at least one of: (i) one or more universal serial bus (USB) device class; (ii) a virtual USB driver; (iii) a secure digital input output (SDIO) driver; (iv) a peripheral component interconnect express (PCIe) driver; (v) inter-integrated circuit (I2C) driver; (vi) service provider interface (SPI); or (vii) general purpose input/Output (GPIO) driver.

16. The electronic device of claim 11, wherein the server management entity is further configured to generate a capability message based at least in part on the one or more components.

17. The electronic device of claim 16, wherein the server management entity is further configured to receive, responsive to transmitting the capability message, a capability request message.

18. At least one computer-readable medium comprising computer-executable instructions that, when executed by one or more processors, executes a method comprising:
identifying one or more device capabilities;
establishing a communicative connection with a client device;
generating a capability message based at least in part on the one or more identified device capabilities;
transmitting the capability message to the client device via the communicative connection;
receiving, responsive to transmitting the capability message, a capability request message; and
transmitting a confirmation of a capability connection.

19. The computer-readable medium of claim 18, wherein the one or more device capabilities comprise at least one of: (i) an image capability; (ii) a video capability; (iii) an audio capability; (iv) a user interface capability; (v) a storage capability; (vi) an input/output capability; (vii) a diagnostic capability; or (viii) a communications capability.

20. The computer-readable medium of claim 19, wherein the communicative connection comprises at least one of: (i) a Wi-Fi connection; (ii) a Bluetooth connection; (iii) a direct Wi-Fi connection; (iv) a hardwired connection; (v) WiGig connection; (vi) Institute of Electrical and Electronic Engineers (IEEE) standard 802.11ac based connection; (vii) the Internet; (viii) a wide area network (WAN); (ix) a third generation (3G) wireless connection; (x) a fourth generation (4G) wireless connection; (xi) a long term evolution (LTE) connection; (xii) or (xiii) a network connection.

21. The computer-readable medium of claim 18, wherein the method further comprises establishing the capability connection.

22. The computer-readable medium of claim 21, wherein establishing the capability connection comprises transmitting a transfer signal to the client device.

23. The computer-readable medium of claim 18, wherein the method further comprises receiving a component signal from a component associated with one or more requested capabilities associated with the capability request message.

24. The computer-readable medium of claim 23, wherein the method further comprises determining a virtual driver associated with the component signal.

25. The computer-readable medium of claim 24, wherein the method further comprises generating a transfer signal based at least in part on the component signal and the virtual driver associated with the component signal.
